(19) United States
(12) Patent Application Publication
(10) Pub. No.: US 2019/0023211 A1
(43) Pub. Date: Jan. 24, 2019

(54) VEHICLE SECURITY PARTITION

(71) Applicant: Westin Automotive Products, Inc., San Dimas, CA (US)

(72) Inventor: Carlos Rios, Mira Loma, CA (US)

(21) Appl. No.: 15/657,398

(22) Filed: Jul. 24, 2017

(51) Int. Cl. B60R 21/02; B60R 21/12; B60H 1/00; B60R 13/08

(52) U.S. Cl. CPC B60R 21/026; B60R 13/0823; B60H 1/00592; B60R 21/12

(57) ABSTRACT

The present invention provides a method of installing a security partition into a vehicle comprising: installing the lower mounting assemblies of the partition to the vehicle, attaching the partition body assembly of the partition to the lower mounting assemblies forming pivotable connections in a unlocked position; pivoting the partition into direction of a desired location of the vehicle; attaching the partition to the sides of the vehicle via side mounting brackets; and securing both the pivotable connections into a locked position. The present invention also provides the security partition described herein.

### FIELD OF INVENTION

The present invention relates to vehicle accessory field. More specifically, it relates to a security partition for use in vehicles to form a barrier between the front and rear occupant area.

### BACKGROUND OF INVENTION

Many public vehicles, especially taxis and police cars use a security partition to form a physical barrier between the front and rear occupant areas in order to prevent access to the front occupant area from the rear occupant area. Due to the large size and general shape of the security partition, its installation into a vehicle is labor and time intensive.

### BRIEF DESCRIPTION OF THE DRAWING

The present invention will be more clearly understood when considering the accompanying drawing of which:

FIG. 1 shows a cross-sectional front view of a vehicle with a security partition, in accordance with the principals of the present invention, installed in the rear occupant area of the vehicle;

FIG. 2 shows a front prospective view of the security partition of FIG. 1;

FIG. 3 shows a front prospective view of the structural frame of the security partition of FIG. 2;

FIG. 4 shows a front prospective view of the partition body assembly of the security partition of FIG. 2;

FIG. 5 shows a rear prospective view of one exemplary embodiment of the left lower mounting assembly and the right lower mounting assembly of the security partition of FIG. 2;

FIG. 6 shows a rear prospective view of another exemplary embodiment of a mounting plate of the lower right assembly in accordance to the principles of the present invention;

FIG. 7 shows a rear prospective view of the partition body assembly of FIG. 4 along with the lower right mounting assembly of FIG. 5 installed in the vehicle to a front passenger seat rail;

FIG. 8 shows a rear prospective view of the security partition of FIG. 1 partially installed in a tilted position inside the rear occupant area of the vehicle;

FIG. 9 shows a rear prospective view of the security partition of FIG. 1 completely installed in an upright position inside the rear occupant area of the vehicle;

FIG. 10 shows an enlarged prospective front view of the pivotal connection in a locked upright position between the left lower mounting assembly and the left upright member of the partition of FIG. 1;

FIG. 11 shows an exploded view of the components shown in FIG. 10;

FIG. 12 shows the pivotal connection of FIG. 10 in an unlocked position;

FIG. 13 shows an enlarged prospective front view of another exemplary embodiment of a lower right assembly and a portion of the right upright member of the security partition of FIG. 1; and

FIG. 14 shows an enlarged prospective front view of the components shown in FIG. 13 forming a pivotal connection.

### DESCRIPTION OF THE PREFERRED EMBODIMENT

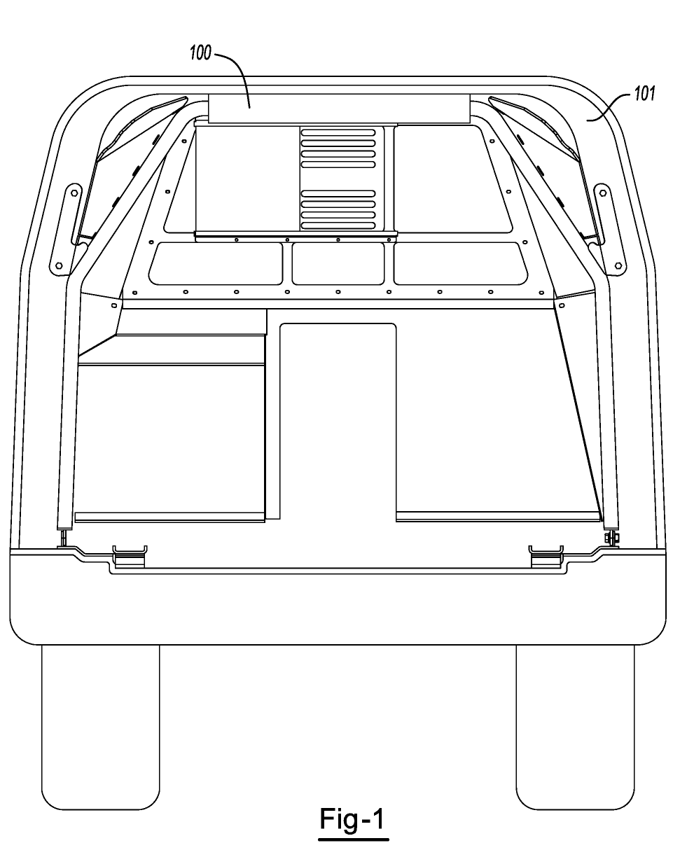

The present invention provides a security partition 100 having pivotable mounting assemblies for easy installation into a vehicle 101, thereby reducing the required installation time and labor. Referring to FIGS. 1, 7-9, the partition 100 is installed in a location 102 between the front occupant area 104 and the rear occupant area 103 of the vehicle 101 in order to form a complete physical barrier between these areas. FIG. 1 shows a cross-sectional front view of the vehicle 101 (e.g., viewing from the front of the vehicle 101 at the location 102 situated immediately behind the front occupant seats). FIGS. 7-9 show rear prospective rear view of the vehicle 101 (e.g., viewing from outside of the left passenger door of the vehicle 101). It is preferred that the location 102 is situated immediately behind the front occupant seats in the rear occupant area 103. It is also preferred that the partition 100 extends from side to side and ceiling to floor 105 of the vehicle 101 conforming to the configuration inside the bulkhead of the vehicle 101, thereby forming a complete physical barrier between the front occupant area 104 and the rear occupant area 103 as shown in FIGS. 1 & 9.

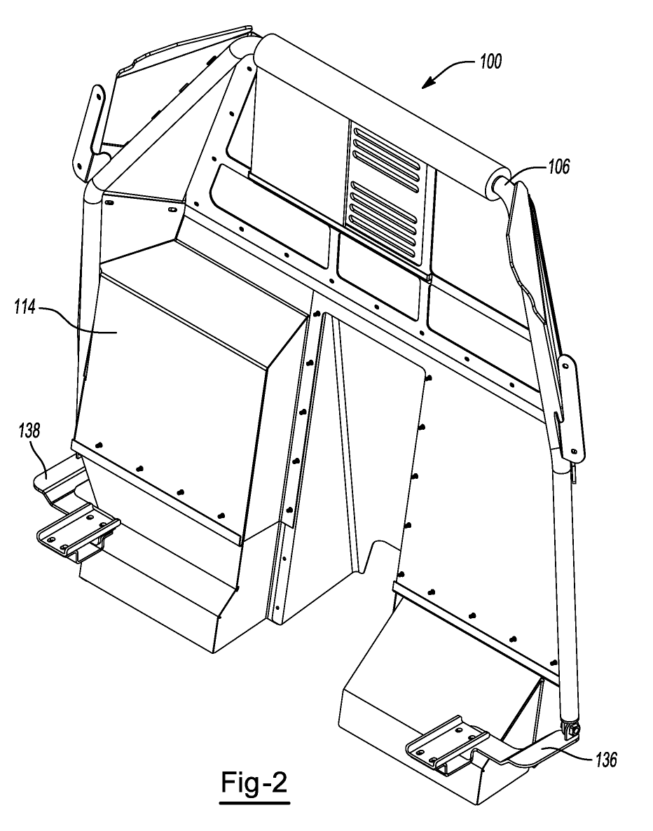

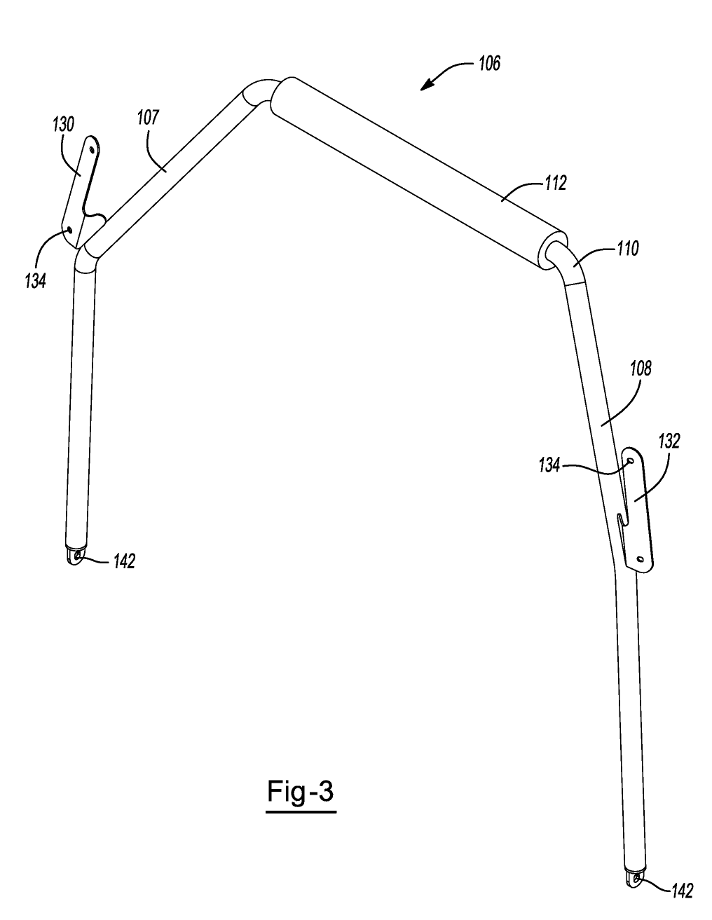

Referring to FIGS. 2-4, the partition 100 includes a partition body assembly 109. The partition body assembly 109 includes a structural frame 106 that conforms to the general shape of the location 102 within the vehicle 101 as shown in FIGS. 1, 3 and 7. The frame 106 includes a right upright member 107 and a left upright member 108 and a generally horizontal member 110. Each of the upright members (107, 108) conforms to the shape of its respective side of the location 102 as shown in FIG. 1 (e.g., in the United States, the right upright member 107 is located behind the front passenger seat and the left upright member 108 is located behind the driver seat). The shape of the horizontal member 110 conforms to the top portion of the location 102. In one exemplary embodiment, the members (107, 108, and 110) of the frame 106 are formed from an integral tubular steel as shown in FIG. 3 and/or aluminum bent into the desired shape(s).

Referring to FIGS. 1-3, a protective sleeve 112 is optionally provided to cover one or more portions of the frame 106 in order to protect the occupants of the vehicle 101. The protective sleeve 112 can be constructed of any suitable art-disclosed material such as plastic, rubber, or other polymeric material.

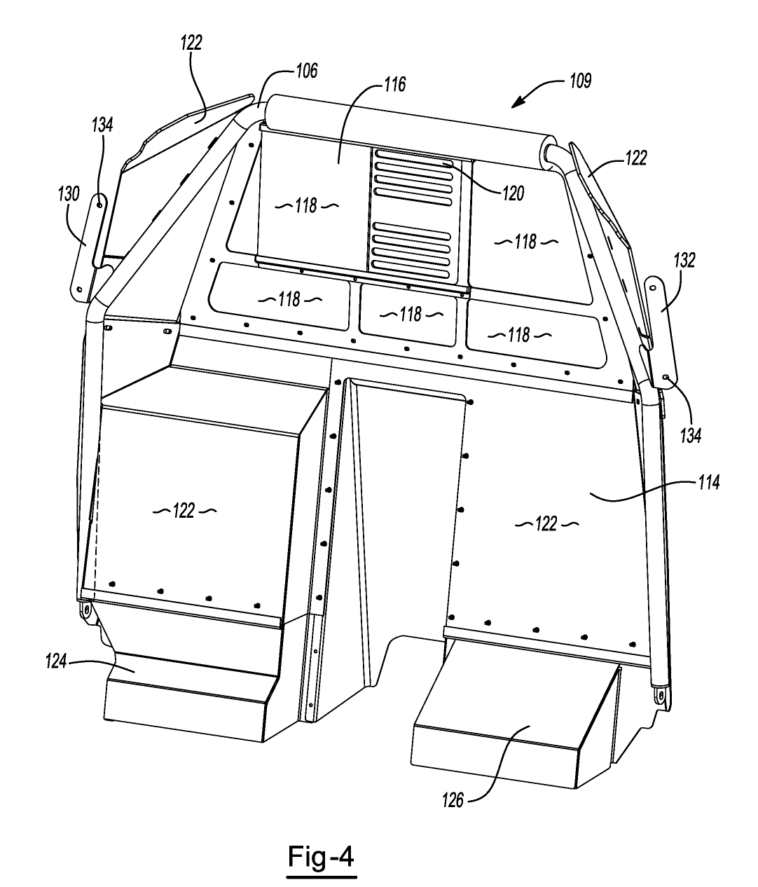

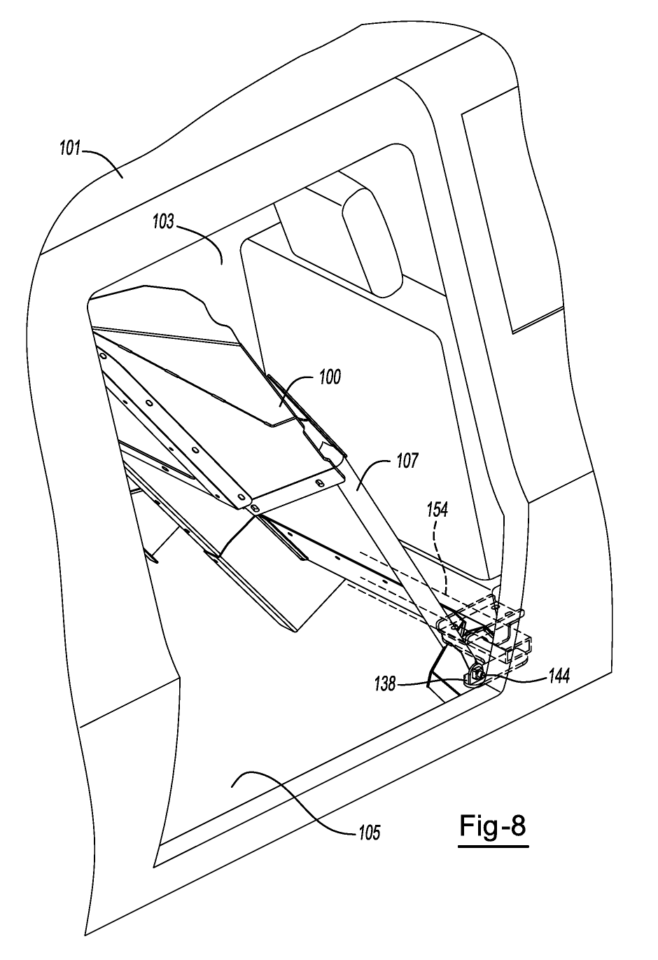

Referring to FIGS. 2 and 4, the partition body assembly 109 further includes a panel assembly 114 attached to the frame 106. The panel assembly 114 and the frame 106 together (e.g., the partition body assembly 109) form the physical barrier between the front occupant area 104 and the rear occupant area 103 as shown in FIGS. 7-8. The panel assembly 114 includes a window 116 that provides a driver with visibility of the rear occupant area 103 including the rear window of the vehicle 101. The window 116 may have either a single pane or multiple panes 118 of impact resistant translucent material for the desired visibility. Alternatively, the window 116 or the entire panel assembly 114 may be constructed of wire mesh (it is preferred that the holes within the wire mesh are sized to prevent finger access to the front occupant area. Furthermore, the window 116 may optionally include (i) slots (or holes) 120 for transmission of air and/or sound, and/or (ii) sliding panes (not shown) for physical access between the front occupant area and the rear occupant area 103.

The panel assembly 114 further includes panel(s) 122 that conforms to the various shaped configurations of the location 102 such as backs of the front occupant seats, console, foot rest areas, etc. It is optional that the panel(s) 122 for foot rest areas (e.g., areas below the front driver and passenger seats that are accessible to the occupants in the rear occupant area 103), hereinafter referred to as a passenger foot panel 124 and a driver foot panel 126, are separate pieces that can be separately installed with conventional fasteners 128 such as bolts, nuts, etc. The panel(s) 122 can be constructed of any suitable art-disclosed material such as thermoplastic, sheet metal, wire mesh, etc.

Referring to FIGS. 1-3, each of the upright members (107, 108) includes a side mounting bracket (130, 132) that secures the partition body assembly 109 to the two sides of the vehicle 101 using conventional fasteners such as threaded bolts or the like. It is optional that the side mounting apertures 134 of the brackets (130, 132) match or correspond to the apertures already available on the sides of the vehicle 101 in order to avoid further aperture drillings.

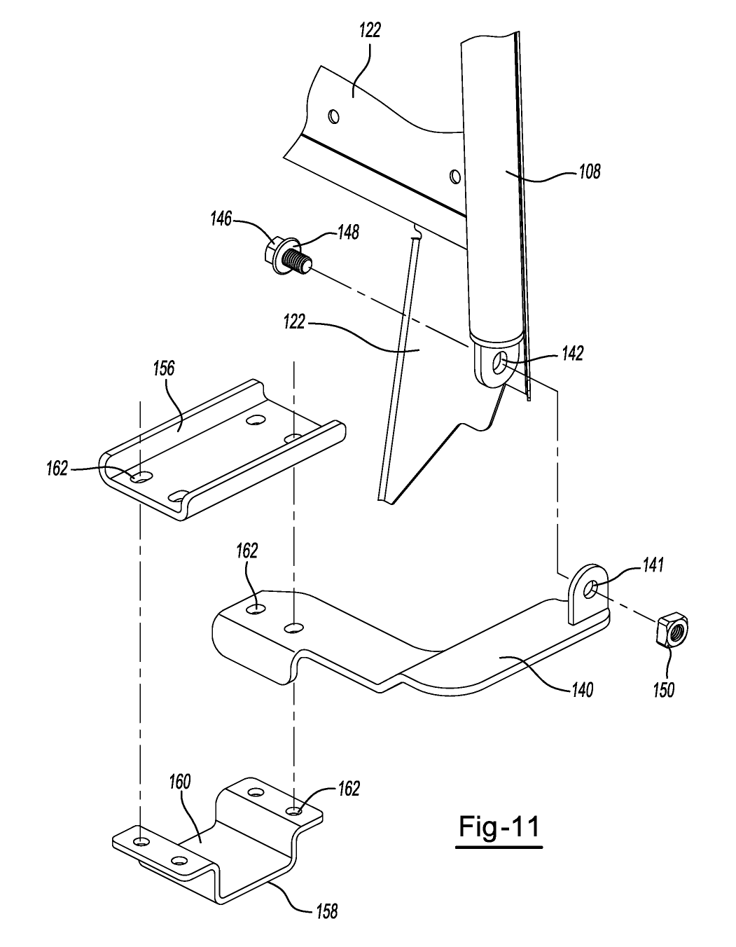

Referring to FIGS. 2, 5, and 8-12, the partition 100 further includes a left lower mounting assembly 136 and a right lower mounting assembly 138. These mounting assemblies (136, 138) connect the partition 100 to the vehicle 101. Each of these mounting assemblies (136, 138) includes a mounting plate 140 for attaching or coupling to its corresponding upright member (107, 108) via a mounting plate coupler 141 and an upright member coupler 142 in a pivotable but ultimately upright (e.g., generally vertical) fashion using conventional fastener means to form a pivotable connection 144. For example, in the embodiment of the partition 100 shown in FIGS. 1-12, the mounting plate coupler 141 and the upright member coupler 142 are both apertures and they are attached by the conventional fastener means such as a threaded bolt 146, a washer 148, and a nut 150 to form the pivotable connection 144. It is optional that the nut 150 is welded to the mounting plate coupler 141. Furthermore, other conventional fastener means can also be used (e.g., a clevis pin secured with a cotter pin or a retaining ring, etc.). Finally, the scope of the present invention includes additional but optional lower mounting assemblies and upright members in order to form additional pivotable connections 144.

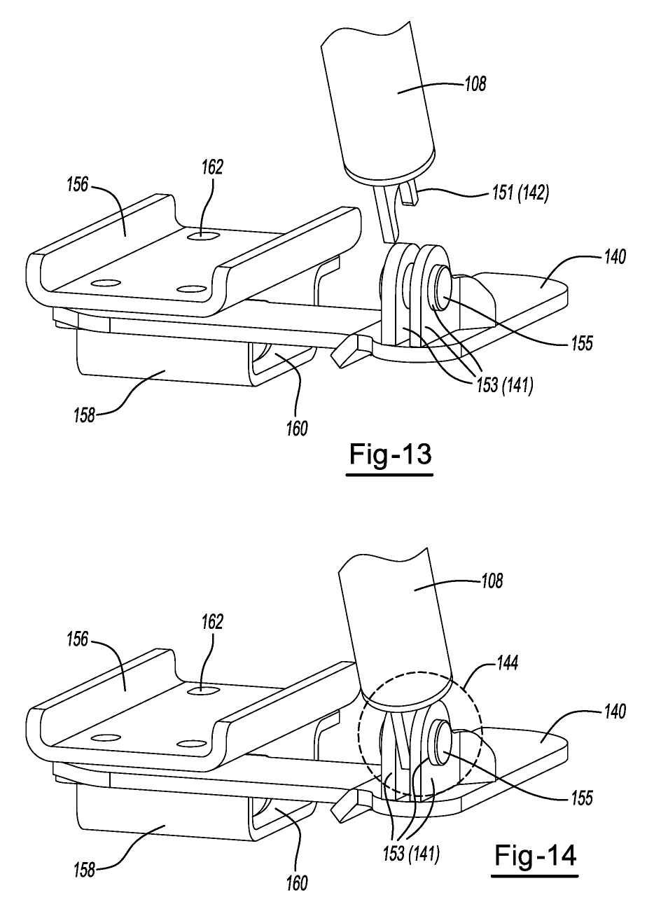

In another exemplary embodiment and referring to FIGS. 13-14, the upright member coupler 142 is a U shaped slot 151 designed to engage with the mounting plate coupler 141 which is a fork joint 153. The pin 155 of the fork joint is welded to the dual plates 157 of the fork joint 153. Alternatively, the pin 155 can be a clevis pin secured within the dual plates by a cotter pin. The pivotable connection 144 formed by these fork joint couplers (141, 142) will be held in a locked position once the side mounting brackets (130, 132) are mounted to the vehicle 101.

Each of the lower mounting assemblies (136, 138) further includes vehicle attachment means 152 for attaching it (136 or 138) to the rear occupant area 103 of the vehicle 101. In one exemplary embodiment and referring to FIGS. 7, 10-12, the vehicle attachment means 152 is designed to attach to a front seat rail 154 (e.g., the front seat rail 154 located closest to the rear occupant area 103). The vehicle attachment means 152 includes an upper rail bracket 156 and a lower rail bracket 158. The lower rail bracket 158 includes a rail channel 160 for engagement with the outer seat rail 154 (e.g., as shown in FIG. 7). The direction (e.g., horizontal or vertical), size, and shape of the rail channel 160 are dependent upon the design of the front seat rail 154. Once the vehicle attachment means 152 is engaged with the front seat rail 154, the brackets (156, 158) and the mounting plate are all attached together via lower mounting apertures 162 and conventional fasteners such as nut and bolts, resulting in a fixed and secured attachment of the lower mounting assembly (136 or 138) to the vehicle 101. It is optional but preferred that the upper rail bracket 156 is welded to (or constructed as a part of) the mounting plate 140.

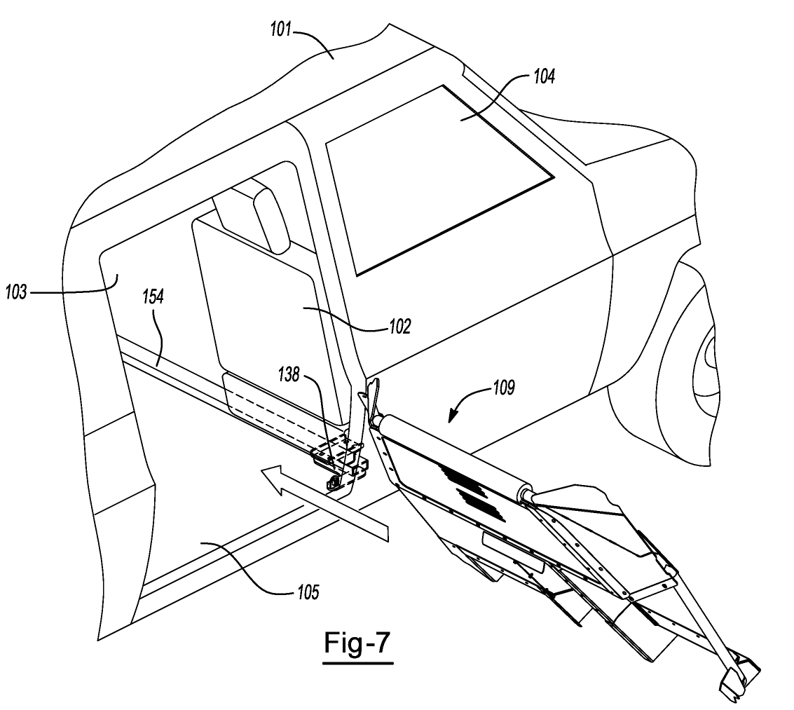

In another exemplary embodiment, the vehicle attachment means 152 is a floor-mounting bracket 164, which optionally can be either welded to or constructed as a part of the mounting plate 140 as shown in FIG. 6. It should be noted that the floor-mounting bracket 166 might have a right side version and a left side version (e.g., mirror image of each other) in order to provide for a more desirable styling and fit into the desired location within the vehicle 101. For example, the floor-mounting bracket 165 may secure the mounting plate 140 to the floor 105 of the rear occupant area 103 using floor mounting apertures 166 and conventional fasteners such as threaded bolts or the like. It is optional that the floor mounting apertures 166 match or correspond to the apertures already available on the floor 105 in order to avoid further aperture (e.g., hole or the like) drillings.

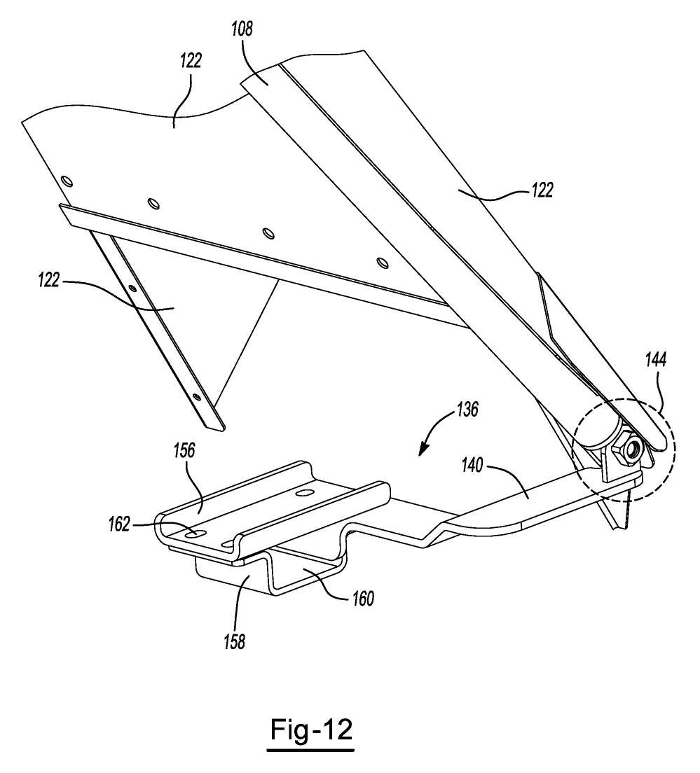

The pivotable connections 144 between the upright members (107, 108) and their respective mounting plates 140 provide for a quick and easy installation of the partition 100 using the method of the present invention. The present invention provides an improved method of installing the partition 100 into a vehicle comprising the following steps: First, each of the lower mounting assemblies (136, 138) is attached via the vehicle attachment means 152 to the vehicle 101 through either the front seat rail 154 (as shown in FIG. 7) or the floor 105. Second, the partition body assembly 109 is then placed into the rear occupant area 103 in a slanted fashion as shown in FIG. 7. The slanted fashion allows the partition body assembly 109 to enter through the passenger door into the rear occupant area 103 in a more accessible way. Third, the partition body assembly 109 (still in a slanted or not fully right fashion) is attached to the lower mounting assemblies (136, 138) via the pivotable connections 144 in an unlocked position as shown in FIGS. 8 and 12. The pivotable connections 144 are formed when each of the mounting plates 140 is attached to its corresponding upright member (107, 108) via the mounting plate coupler 141 and the upright member mounting coupler 142 using conventional fastener means 144 (e.g., by the bolt 146 going through the washer 148, the these couplers (141, 142) and then threadably engaged with the nut 150).

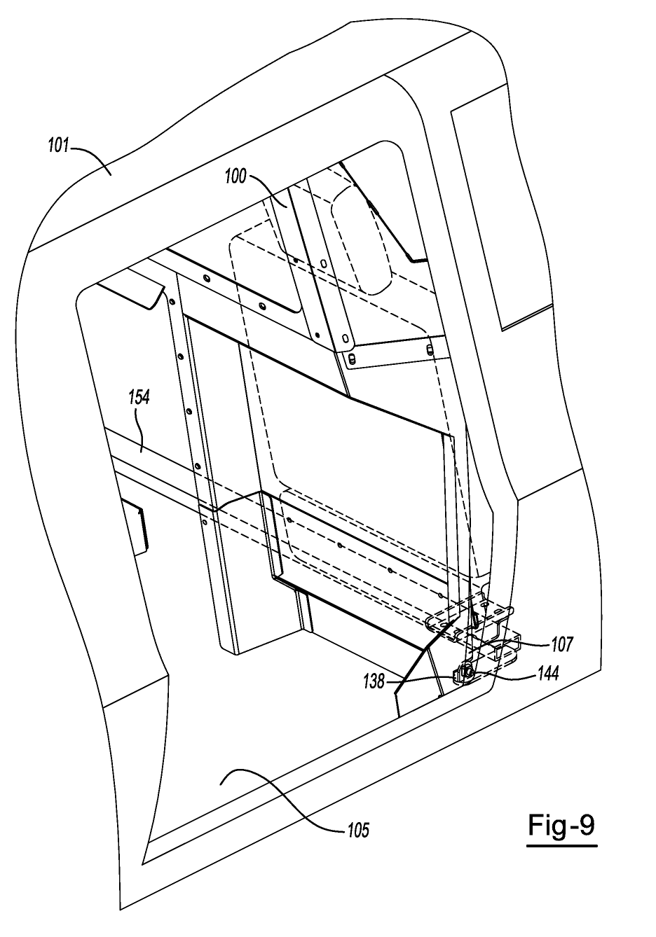

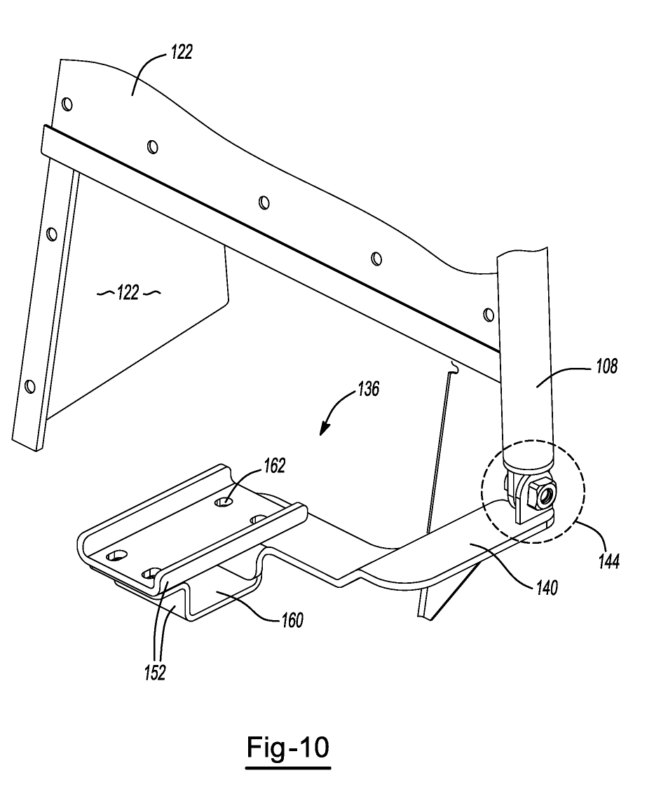

The pivotable connection 144 in an unlocked position for the right side of the partition body assembly 109 is shown in FIGS. 8 and 12. The unlocked position is defined having the pivotable connections 144 still allowing some movement to the partition body assembly 109 thereby allowing its upright members (107, 108) to pivot upward toward the front occupant area 104. Finally, after the partition body assembly 109 has been moved into the desired location 102 (as shown in FIGS. 7-8), the pivotable connections 144 are set to a locked position by tightening the conventional fastener means 144 (e.g., having the bolt fully engaged with the nut) thereby allowing no further movement of the partition body assembly 109 as shown in FIGS. 9 and 10. Alternatively, the partition body assembly 109 is first placed and then installed into the location 102 without its foot panels (124, 126) as shown in FIGS. 7-12. Once the partition body assembly 109 (without the foot panels 124, 126) has been installed at the location 102, then the foot panels (124, 126) are installed at the location with conventional fastener means such as threaded bolts. The foot panels can be installed before or after the pivotable connections are set to a locked position.

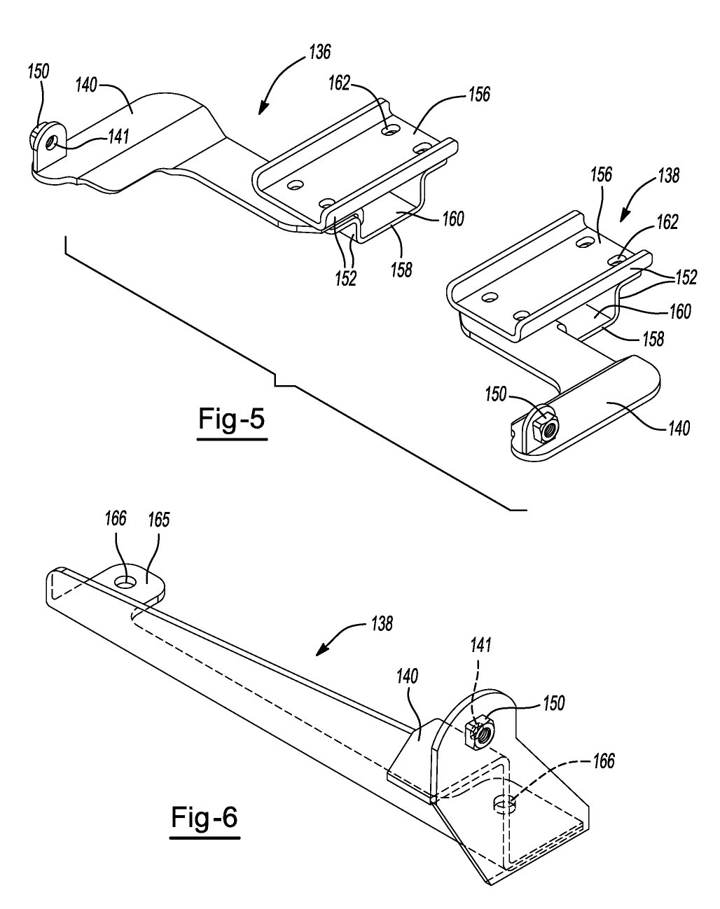

Please note that FIGS. 2-4 and 10-13 provide front prospective views of the described components while FIGS. 5-9 provide the opposite: back prospective views of the described components.

The above-described components of the partition 100 may be constructed out of any suitable art-disclosed material. Examples of such material are polycarbonate and other polymeric material, steel including but are not limited to stainless steel, cold rolled steel, mild steel, high strength steel, tempered steel, aluminum, and other metal alloys. The thickness of each individual component may vary. Examples of suitable thickness are in the range from about 1/16″ to about 1/2″ and from about 1 mm to about 6 mm. The exact size and shape of the partition 100 will vary depending on the configuration of the vehicle 101.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

What is claimed is:

1. A security partition for a vehicle comprising:
a partition body assembly comprising a frame and a panel assembly;
a left lower mounting assembly having (a) vehicle attachment means used to attach the left lower mounting assembly to the vehicle, (b) a mounting plate having a mounting plate coupler; and (c) conventional fastener means; and
a right lower mounting assembly having (a) vehicle attachment means used to attach the left lower mounting assembly to the vehicle, (b) a mounting plate having a mounting plate coupler; and (c) conventional fastener means; wherein
i. the frame includes (a) a left upright member having an upright member mounting coupler and a left side mounting bracket; and (b) a right upright member having an upright member mounting coupler and a right side mounting bracket;
ii. the panel assembly includes a window and panels;
iii. the left lower mounting assembly and the left upright member forms a first pivotable connection when the mounting plate coupler, the upright member coupler, and the conventional fastener means are connected together;
iv. the right lower mounting assembly and the right upright member forms a second pivotable connection when the mounting plate coupler, the upright member coupler, and the conventional fastener means are connected together; and
v. the first pivotable connection and the second pivotable connection allow the partition body assembly to pivot toward a desired installation location within rear occupant area of the vehicle.

2. The security partition of claim 1 wherein the desired installation location is behind the front occupant seats.

3. The security partition of claim 1 further comprising a passenger foot panel and driver food panel.

4. The security partition of claim 1 wherein the security partition forms a complete physical barrier between front occupant area and the rear occupant area.

5. The security partition of claim 1 wherein the frame includes a protective sleeve.

6. The security partition of claim 1 wherein the window is comprised of multiple panes of translucent material.

7. The security partition of claim 1 wherein the panel assembly is constructed of wire mesh.

8. The security partition of claim 1 wherein the left side mounting bracket and the right side mounting bracket are designed to attach to sides of the vehicle via the vehicle's pre-existing drill holes.

9. The security partition of claim 1 wherein the left lower mounting assembly and the right lower mounting assembly are attached to the vehicle via the vehicle attachment means and at least one seat rail of the vehicle.

10. The security partition of claim 1 wherein the left lower mounting assembly and the right lower mounting assembly are designed to attach to floor of the vehicle via the vehicle attachment means and the vehicle's pre-existing drill holes.

11. A method of installing a security partition into a vehicle comprising:
providing a security partition comprising:
a partition body assembly comprising a frame and a panel assembly;
a left lower mounting assembly having (a) vehicle attachment means used to attach the left lower mounting assembly to the vehicle, (b) a mounting plate having a mounting plate coupler; and (c) conventional fastener means; and
a right lower mounting assembly having (a) vehicle attachment means used to attach the left lower mounting assembly to the vehicle, (b) a mounting plate having a mounting plate coupler; and (c) conventional fastener means; wherein
i. the frame includes (a) a left upright member having an upright member mounting coupler and a left side mounting bracket; and (b) a right upright member having an upright member mounting coupler and a right side mounting bracket;
ii. the panel assembly includes a window and panels;
attaching (a) the left lower mounting assembly to left side of the vehicle and (b) the right lower mounting assembly to the right side of the vehicle;
placing the partition body assembly into the rear occupant area of the vehicle;
attaching the left lower mounting assembly to the left upright member by connecting the mounting plate coupler, the upright member coupler, and the conventional fastener means together forming a first pivotable connection in an unlocked position;
attaching the right lower mounting assembly to the right upright member by connecting the mounting plate coupler, the upright member coupler, and the conventional fastener means together forming a second pivotable connection in an unlocked position;
pivoting the partition into direction of a desired location of the vehicle
attaching the partition to the sides of the vehicle via the left side mounting bracket and the right side mounting bracket; and
securing both the first pivotable connection and the second pivotable connection in a locked position.

12. The method of claim 11 wherein the desired installation location is behind the front occupant seats.

13. The method of claim 11 further comprising attaching a passenger foot panel and driver food panel to the partition.

14. The method of claim 11 wherein the security partition forms a complete physical barrier between front occupant area and the rear occupant area.

15. The method of claim 11 wherein the frame includes a protective sleeve.

16. The method of claim 11 wherein the window is comprised of multiple panes of translucent material.

17. The method of claim 11 wherein the panel assembly is constructed of wire mesh.

18. The method of claim 11 wherein the left side mounting bracket and the right side mounting bracket are attached to sides of the vehicle via the vehicle's pre-existing drill holes.

19. The method of claim 11 wherein the left lower mounting assembly and the right lower mounting assembly are attached to the vehicle via the vehicle attachment means and at least one seat rail of the vehicle.

20. The method of claim 11 wherein the left lower mounting assembly and the right lower mounting assembly are attached to floor of the vehicle.
